(19) United States
(12) Patent Application Publication
(10) Pub. No.: US 2006/0081024 A1
(43) Pub. Date: Apr. 20, 2006

(54) Door handle insert

(75) Inventor: Gregory K. Heimbuck, Colorado Springs, CO (US)

Correspondence Address: MICHAEL BEST & FRIEDRICH, LLP, 100 E WISCONSIN AVENUE, MILWAUKEE, WI, 53202, US

(73) Assignee: Schlage Lock Company, Indianapolis, IN (US)

(21) Appl. No.: 10/967,378

(22) Filed: Oct. 18, 2004

(51) Int. Cl. E05B 13/10

(52) U.S. Cl. 70/224

(57) ABSTRACT

A door handle assembly that includes a substantially hollow knob shell having a front opening and a rear opening. A lock cylinder includes a front end formed to include a key passage. The front portion is disposed at least partially within the front opening. A sleeve is disposed within the hollow knob shell. The lock cylinder is at least partially supported by the sleeve.

### BACKGROUND

The present invention relates generally to an insert for a door handle. More particularly, the present invention relates to a hollow door handle that includes an insert that supports a lock cylinder.

Door handles are often manufactured using hollow shells to reduce the quantity of material required, and to provide a space for a key cylinder. However, the use of a hollow door handle may allow the key cylinder to drop into the hollow space and position itself in an undesirable location that is difficult to access even with special tools. In addition, when positioned in the hollow space, there is generally no component provided to inhibit rotation of the entire cylinder in response to rotation of the key.

### SUMMARY

The invention provides a door handle assembly that includes a substantially hollow knob shell having a front opening and a rear opening. A lock cylinder includes a front portion formed to include a key passage. The front portion is disposed at least partially within the front opening. A sleeve is completely disposed within the hollow knob shell. The lock cylinder is at least partially supported by the sleeve.

In another aspect, the invention provides a door handle assembly that includes a substantially hollow knob shell that defines an axis that extends through a front opening and a rear opening. The handle assembly also includes a lock cylinder that has a front portion formed to include a key passage. The front portion is disposed at least partially within the front opening. A substantially tubular sleeve is disposed completely within the hollow knob shell and extends along the axis between the front opening and the rear opening. The sleeve includes a slot that extends the full length of the sleeve substantially parallel to the axis.

In yet another aspect, the invention provides a door handle assembly that includes a hollow knob shell that has a hand portion defining a first inner space and a substantially circular edge that at least partially defines a front opening. The circular edge is disposed at least partially within the first inner space. The hollow knob shell also includes a substantially tubular neck portion that extends from the hand portion and defines a second inner space and a rear opening. A lock cylinder includes a front end formed to include a key passage. The front portion is disposed at least partially within the front opening. A sleeve is disposed substantially within the first inner space.

Additional features and advantages will become apparent to those skilled in the art upon consideration of the following detailed description of preferred embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a portion of a door including a door handle assembly;

FIG. 2 is a partially broken away perspective view of a portion of the door handle assembly of FIG. 1 including a sleeve; and

FIG. 3 is a perspective view of the sleeve of FIG. 2.

Before any embodiments of the invention are explained, it is to be understood that the invention is not limited in its application to the details of construction and the arrangements of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof is meant to encompass the items listed thereafter and equivalence thereof as well as additional items. The terms “connected,” “coupled,” and “mounted” and variations thereof are used broadly and encompass direct and indirect connections, couplings, and mountings.

### DETAILED DESCRIPTION

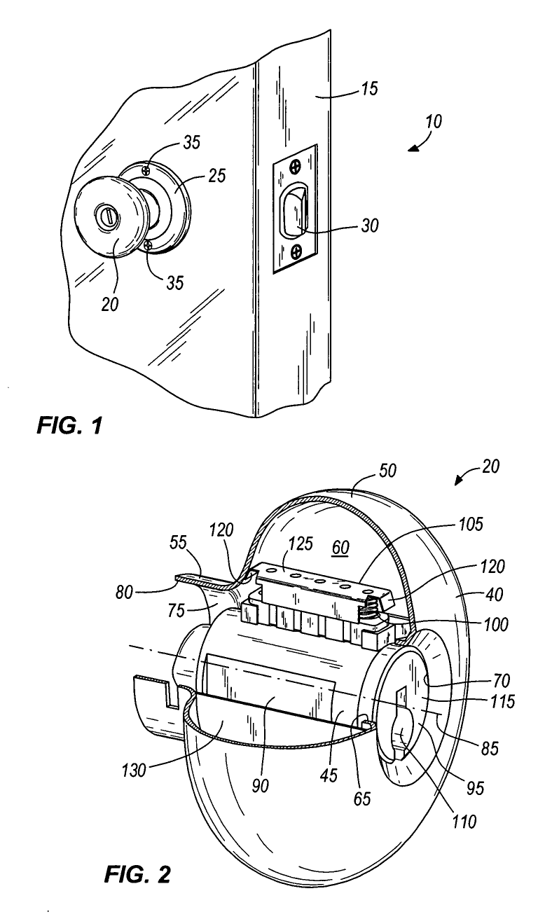

FIG. 1 illustrates a door handle assembly 10 positioned within a door 15. The door handle assembly 10 includes a knob portion 20, a skirt 25, and a spindle 30 that moves between an engaged position and a disengaged position in response to rotation of the knob portion 20. When in the engaged position, the spindle 30 engages a pocket formed in a door jam (not shown) to hold the door 15 in a closed position. When in the disengaged position, the spindle 30 retracts within or substantially within the door 15 to allow the door 15 to move freely between a closed position and an open position.

The skirt 25 is a substantially decorative piece that covers a hole in the door 15 that is formed to facilitate the attachment of the door handle assembly 10 to the door 15. Two fastener holes pass through the skirt 25 and allow for the insertion of fasteners 35 (e.g., screws) that attach the skirt 25 to the door 15.

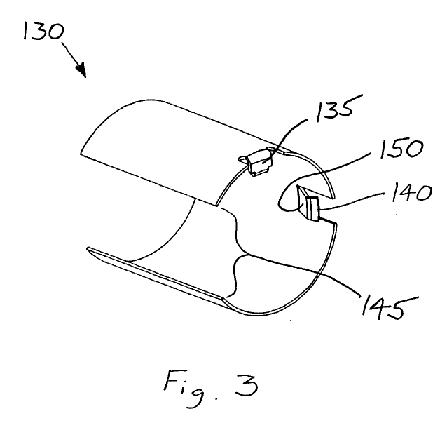

With reference to FIG. 2, the knob portion 20 is shown partially broken away to illustrate the internal components. The knob portion 20 includes a knob shell 40 and a cylinder 45 disposed substantially within the knob shell 40. The knob shell 40 is a substantially hollow member that may be formed from a metal (e.g., steel, brass, bronze, aluminum, and the like) with other suitable materials also being used. The knob shell 40 includes a hand portion 50 and a neck portion 55 that extends from the rear of the hand portion 50. The hand portion 50 is substantially hollow and defines a first inner space 60. The hand portion 50 provides an interface that the user can grab and rotate to move the spindle 30 and open or close the door 15. A perimeter or edge portion 65 extends into the first inner space 60 and surrounds or defines a front opening 70 in the knob shell 40. The edge portion 65 is substantially circular with other shapes being possible.

The neck portion 55 is substantially tubular such that it defines a second inner space 75 that is connected with the first inner space 60. The neck portion 55 extends from the rear of the hand portion 50 and defines a rear opening 80. A central axis 85 extends through the center of the front opening 70 and through the center of the rear opening 80.

In most constructions, the hand portion 50 and the neck portion 55 are formed simultaneously as a single component. However, some constructions may employ a knob shell 40 made of two or more pieces that attach (e.g. weld) to one another.

The cylinder 45 includes a housing 90, a plug 95, a plurality of pins (not shown), a plurality of springs 100, and a cap 105. The plug 95 includes a key slot opening 110 that is sized to receive a key and that extends rearwardly along the central axis 85 from a front face 115. The plug 95 is positioned substantially within the housing 90 and is rotatable relative to the housing 90 to move the plug 95 between an engaged and a disengaged position, as is well known in the art of locks.

The housing 90 remains substantially stationary relative to the knob shell 40 and provides support for the pins and the springs 100. The pins are arranged in a row that extends along the central axis 85. This arrangement spaces the pins apart from one another and allows for movement of the pins along substantially parallel axes in response to the insertion of the key in the key slot opening 110 as is also well known in the art of locks. The springs are positioned on top of the pins such that the springs apply a biasing force toward the key slot. Thus, the springs resist the movement of the pins produced when the key is inserted in the key slot opening.

The cap 105 rests on top of the springs 100 and holds the springs 100 in a desired position such that each spring 100 is able to apply the desired downward biasing force (i.e., toward the central axis 85) to one of the pins. The cap 105 is free to move down (i.e., toward the central axis 85) a predetermined distance. This downward movement reduces the size of the cylinder 45 and allows for the insertion of the cylinder 45 into the knob shell 40 through the rear opening 80. The cap 105 also includes end portions 120 that are angled relative to a cap top 125 such that they push the cap 105 towards the downward position when they contact the knob shell 40. Thus, the end portions 120 facilitate the insertion, and removal, of the cylinder 45 from the knob shell 40 via the rear opening 80.

The cylinder 45 fits within the knob shell 40 such that the front face 115 of the plug 95 is positioned adjacent the front opening 70. A sleeve 130 is positioned within the knob shell 40 such that the sleeve 130 inhibits the movement of the cylinder 45 into undesirable positions within the first inner space 60. The sleeve 130 extends from adjacent the front opening 70 to the neck portion 55 such that a substantial portion, or preferably the entire sleeve 130, is positioned within the first inner space 60.

As illustrated in FIG. 3, the sleeve 130 is a substantially tubular member that may include a tab member 135 and a biasing member 140 positioned at one end of the sleeve 130. The sleeve 130 also includes a slot 145 that extends the full length of the sleeve 130. The tab member 135, if employed, extends inwardly and engages the edge portion 65 to aid in positioning the sleeve 130 within the hand portion 50 as desired. In other constructions, the resiliency, or spring back of the sleeve 130 is sufficient to maintain the sleeve 130 in the desired position.

The biasing member 140 is disposed opposite the slot 145 to bias the cylinder 45 toward the slot 145 when the cylinder 45 is inserted into the knob shell 40. The biasing member 140 includes a ramp portion 150 that guides the cylinder 45 toward the slot 145. The biasing member 140 is able to deflect slightly to accommodate tolerances in the manufacture and positioning of the sleeve 130.

The size and position of the slot 145 allows for the receipt of the top of the housing 90, including the springs 100 and the cap 105. Thus, with the sleeve 130 installed within the knob shell 40, as illustrated in FIG. 2, the cylinder 45 can only be inserted in one orientation. The slot 145 also engages the housing 90 to inhibit rotation of the housing 90 when the key and plug 95 are rotated.

The slot 145 also facilitates the insertion of the sleeve 130 into the knob shell 40. The sleeve 130 is compressed to a smaller diameter. Depending on the material used to form the sleeve 130, a special tool may be required to compress the sleeve 130. For example, stiff spring steel may require a special clamp to compress the sleeve 130 to the desired diameter. Once compressed, the sleeve 130 is inserted into the knob shell 40 though the rear opening 80. Once in place, the sleeve 130 is releases and allowed to spring out toward its stress free position. However, the space in which the sleeve 130 is located is generally slightly smaller than the free size of the sleeve 130. As such, the sleeve 130 remains slightly compressed. This slight compression aids in maintaining the sleeve 130 in the desired position.

The arrangement just described allows the sleeve 130 to be solely supported by the knob shell 40. Specifically, the sleeve 130 is held in place between the edge portion 65 and an inward edge 155 of the neck portion 55.

It should be noted that the illustrated hand portion 50 is circular. However, as one or ordinary skill will realize, there are many other shapes that could be used to define the hand portion 50. As such, the invention should not be limited to knob shells 40 or door knob assemblies 10 shaped as illustrated herein.

Although the invention has been described in detail with reference to certain preferred embodiments, variations and modifications exist within the scope and spirit of the invention as described and defined in the following claims.

What is claimed is:

1. A door handle assembly comprising:
a substantially hollow knob shell including a front opening and a rear opening;
a lock cylinder including a front portion formed to include a key passage, the front portion disposed at least partially within the front opening; and
a sleeve disposed completely within the hollow knob shell, the lock cylinder at least partially supported by the sleeve.

2. The door handle of claim 1, wherein the hollow knob shell includes a hand portion that defines a first inner space and a neck portion that defines a second inner space, and wherein the sleeve is disposed substantially within the first inner space.

3. The door handle of claim 2, wherein the sleeve is disposed completely within the first inner space.

4. The door handle of claim 1, wherein the sleeve is substantially tubular and defines a slot that extends the full axial length of the sleeve.

5. The door handle of claim 4, wherein the lock cylinder includes a plurality of pins and a cap, and wherein the cap is disposed at least partially within the slot.

6. The door handle of claim 4, wherein the sleeve includes a biasing member engageable with the cylinder to bias the cylinder toward the slot.

7. The door handle of claim 1, wherein the sleeve includes a tab member engageable with the knob shell to at least partially retain the sleeve within the knob shell.

8. The door handle of claim 1, wherein the sleeve is solely supported by the knob shell.

9. A door handle assembly comprising:
a substantially hollow knob shell defining an axis that extends through a front opening and a rear opening;
a lock cylinder including a front portion formed to include a key passage, the front portion disposed at least partially within the front opening; and
a substantially tubular sleeve disposed completely within the hollow knob shell and extending along the axis between the front opening and the rear opening, the sleeve including a slot that extends the full length of the sleeve substantially parallel to the axis.

10. The door handle of claim 9, wherein the hollow knob shell includes a hand portion that defines a first inner space and a neck portion that defines a second inner space, and wherein the sleeve is disposed substantially within the first inner space.

11. The door handle of claim 10, wherein the sleeve is disposed completely within the first inner space.

12. The door handle of claim 9, wherein the lock cylinder includes a plurality of pins and a cap, and wherein the cap is disposed at least partially within the slot.

13. The door handle of claim 9, wherein the sleeve includes a tab member engageable with the knob shell to at least partially retain the sleeve within the knob shell.

14. The door handle of claim 9, wherein the sleeve includes a biasing member engageable with the cylinder to bias the cylinder toward the slot.

15. The door handle of claim 9, wherein the sleeve at least partially supports the lock cylinder.

16. The door handle of claim 9, wherein the sleeve is solely supported by the knob shell.

17. A door handle assembly comprising:
a hollow knob shell including:
a hand portion defining a first inner space;
a substantially circular edge that at least partially defines a front opening, the circular edge disposed at least partially within the first inner space; and
a substantially tubular neck portion extending from the hand portion and defining a second inner space and a rear opening;
a lock cylinder including a front portion formed to include a key passage, the front portion disposed at least partially within the front opening; and
a sleeve disposed substantially within the first inner space.

18. The door handle of claim 17, wherein the sleeve is disposed completely within the first inner space.

19. The door handle of claim 17, wherein the sleeve is substantially tubular and defines a slot that extends the full axial length of the sleeve.

20. The door handle of claim 19, wherein the lock cylinder includes a plurality of pins and a cap, and wherein the cap is disposed at least partially within the slot.

21. The door handle of claim 19, wherein the sleeve includes a biasing member engageable with the cylinder to bias the cylinder toward the slot.

22. The door handle of claim 17, wherein the sleeve includes a tab member engageable with the knob shell to at least partially retain the sleeve within the knob shell.

23. The door handle of claim 17, wherein the sleeve at least partially supports the lock cylinder.

24. The door handle of claim 17, wherein the sleeve is solely supported by the knob shell.
